(19) United States
(12) Patent Application Publication
(10) Pub. No.: US 2017/0218673 A1
(43) Pub. Date: Aug. 3, 2017

(54) VEHICLE WITH DUAL SLIDING DOORS

(71) Applicant: AM General LLC, South Bend, IN (US)

(72) Inventors: Jamie Pudlo, Rochester Hills, MI (US); David Bjerke, Birmingham, MI (US)

(73) Assignee: AM General LLC, South Bend, IN (US)

(21) Appl. No.: 15/422,776

(22) Filed: Feb. 2, 2017

Related U.S. Application Data
(60) Provisional application No. 62/290,784, filed on Feb. 3, 2016.

(51) Int. Cl. E05D 15/10; B60J 5/06

(52) U.S. Cl. CPC E05D 15/10; B60J 5/06; E05Y 2900/531

(57) ABSTRACT

A vehicle includes a sidewall, a first door moveable between an opened position and a closed position, a second door moveable between an opened position and a closed position, a first track secured to the sidewall and a second track secured to the sidewall. A first roller is connected to the first door and is moveable along the first track as the first door moves between the opened position and the closed position. A second roller is connected to the second door and is movable along the second track to the first track and along the first track to the second track as the second door is moved between the opened position and the closed position.

The present invention relates to vehicles and, in particular, to vehicles with two sliding doors on the same side of the vehicle.

### BRIEF DESCRIPTION OF THE DRAWINGS

FIG. 1 is a side elevational view of a vehicle according to one embodiment of the present invention with the front door in the closed position and the rear door in the open position.

FIG. 2 is a side elevational view of the vehicle of FIG. 1 with the front door in the open position and the rear door in the closed position.

FIG. 3 is a detailed view of the lower guide mechanism for the front door of the vehicle shown in FIG. 1.

FIG. 4 is a cross-sectional view illustrating tracks, rollers and doors that are components of the vehicle shown in FIG. 1.

FIG. 5 is an exterior perspective view of the vehicle in FIG. 1 with the front and rear doors in the closed position.

FIG. 6 is an interior perspective view of the vehicle of FIG. 1 with the front and rear doors in the closed position.

FIG. 7 is an exterior perspective view of the vehicle of FIG. 1 with the front door in the open position and the rear door in the closed position.

FIG. 8 is an exterior perspective view of the vehicle of FIG. 1 with the front door in the closed position and the rear door in the open position.

FIG. 9 is an interior perspective view of the vehicle of FIG. 1 with the rear door in the open position and the front door in the closed position.

### SUMMARY OF THE INVENTION

In one embodiment of the present invention, a vehicle includes a sidewall, a first door moveable between and opened position and a closed position, a second door moveable between an opened position and a closed position, a first track secured to the sidewall, a second track secured to the sidewall, a first roller connected to the first door and moveable along the first track as the first door moves between the opened position and the closed position and a second roller connected to the second door and movable along the second track to the first track and along the first track to the second track as the second door is moved between the opened position and the closed position.

### DETAILED DESCRIPTION OF THE EMBODIMENTS OF THE INVENTION

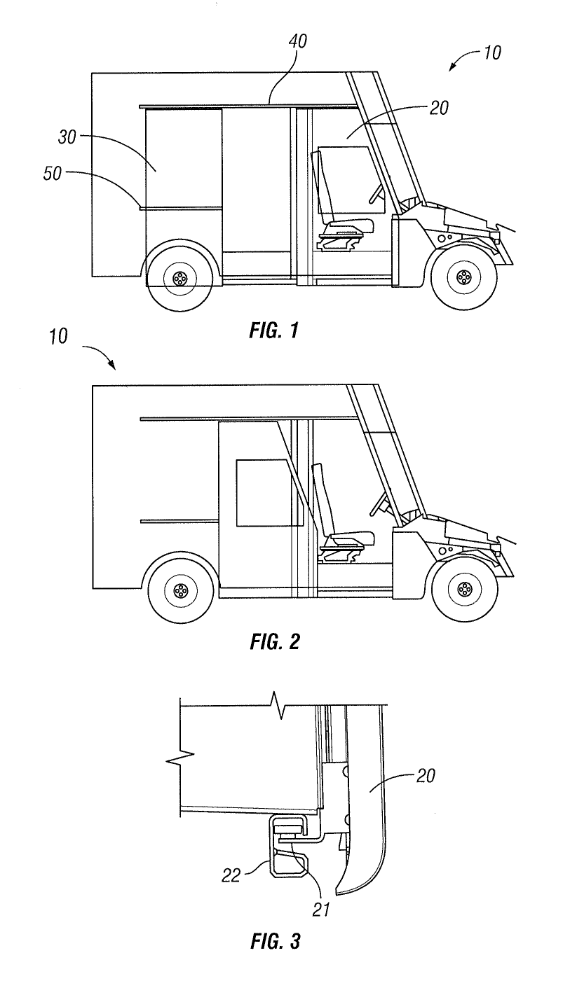

As shown in FIGS. 1 and 2, vehicle 10 includes a sidewall 12, a first or front door 20, a second or rear door 30, a pair of upper tracks 40 and a middle track 50. Upper tracks 40 and middle track 50 are secured to sidewall 12 of vehicle 10 or elsewhere on the upper body of vehicle 10. In FIG. 1, front door 20 is shown in the closed position and rear door 30 is shown in the open position. In FIG. 2, rear door 30 is shown in the closed position and front door 20 is shown in the open position substantially overlapping rear door 30.

As described in greater detail below, the weight of front door 20 and rear door 30 is supported by upper tracks 40. The weight of rear door 30 could also be supported by middle track 50 if desired. Front door 20 is guided at its lower end by a roller 21 engaged with a lower track 22 (FIG. 3). Rear door 30 is not guided at its lower end.

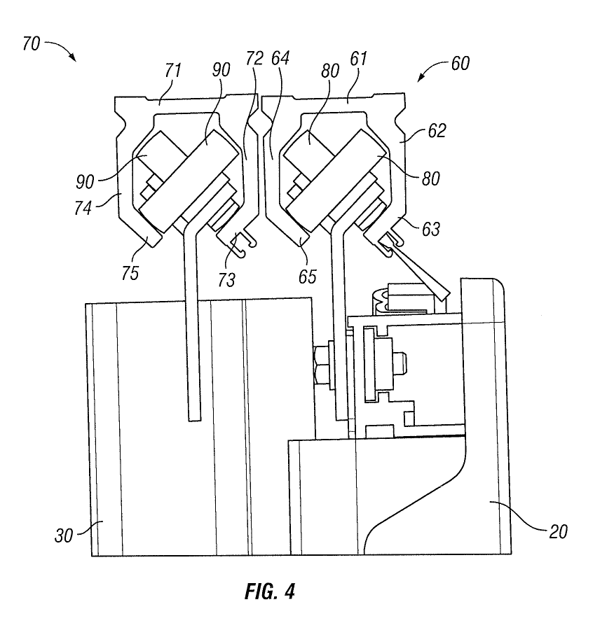

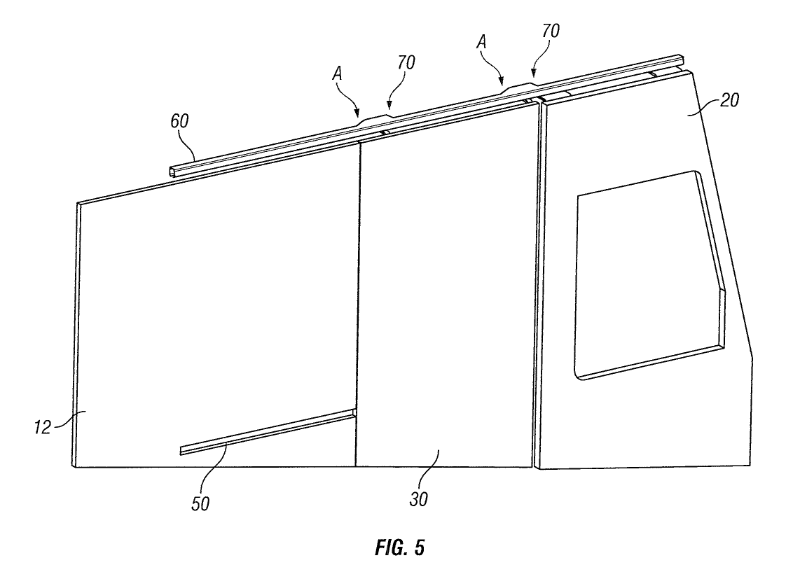

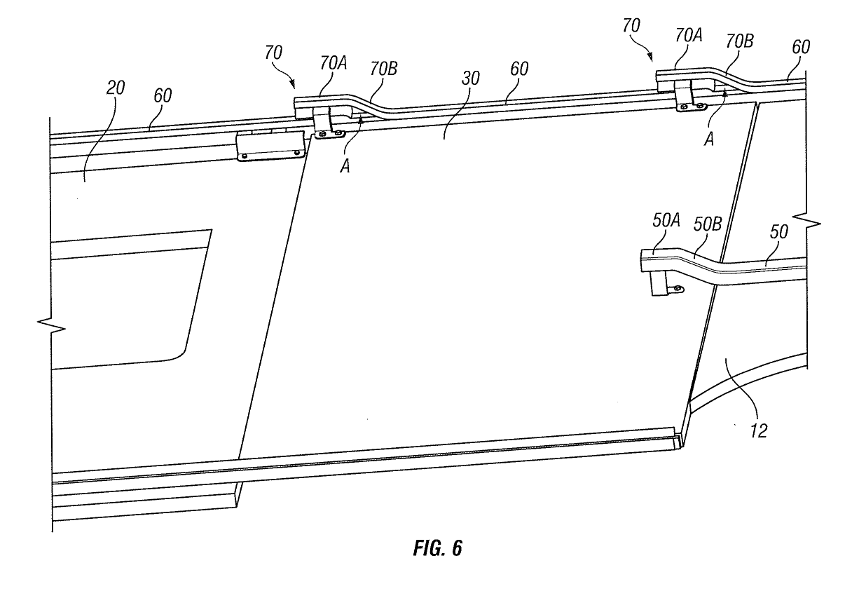

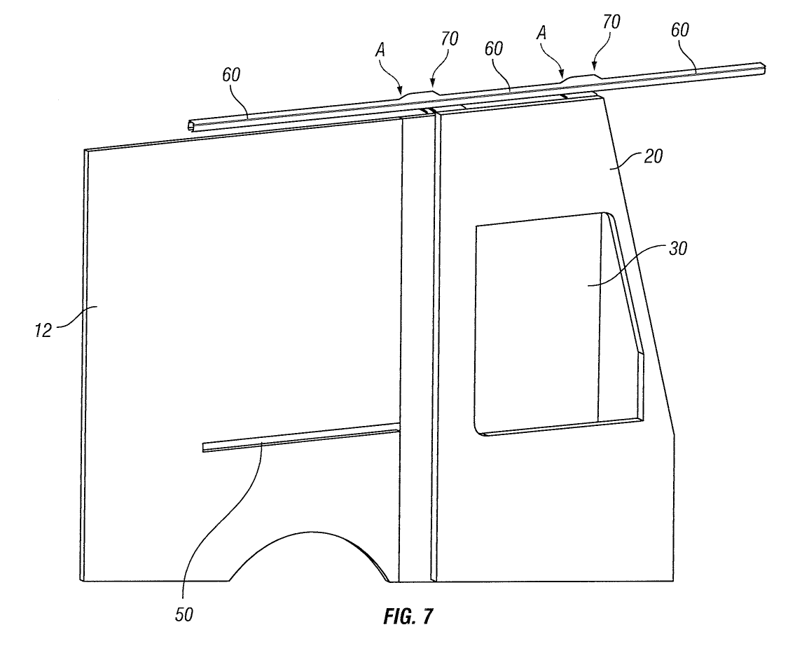

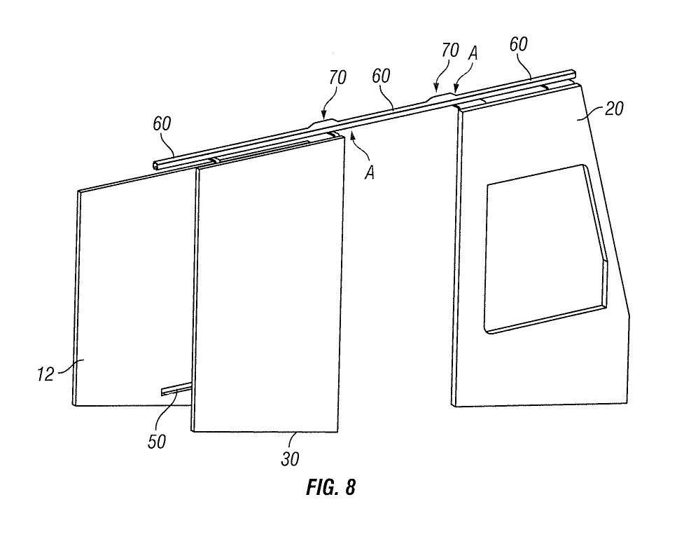

As shown in FIGS. 4 and 6, upper tracks 40 include a first or outer track 60 and a pair of second or inner tracks 70. In the embodiment shown, outer track 60 has an upper section 61, an outer section 62 extending generally perpendicular to upper section 61, an inwardly extending section 63 extending at an angle from outer section 62, an inner section 64 and an outwardly extending section 65 extending at an angle from inner section 64. A section of inner section 64 and outwardly extending section 65 is cut away at locations A adjacent each of the inner tracks 70, the purpose of which will be explained below.

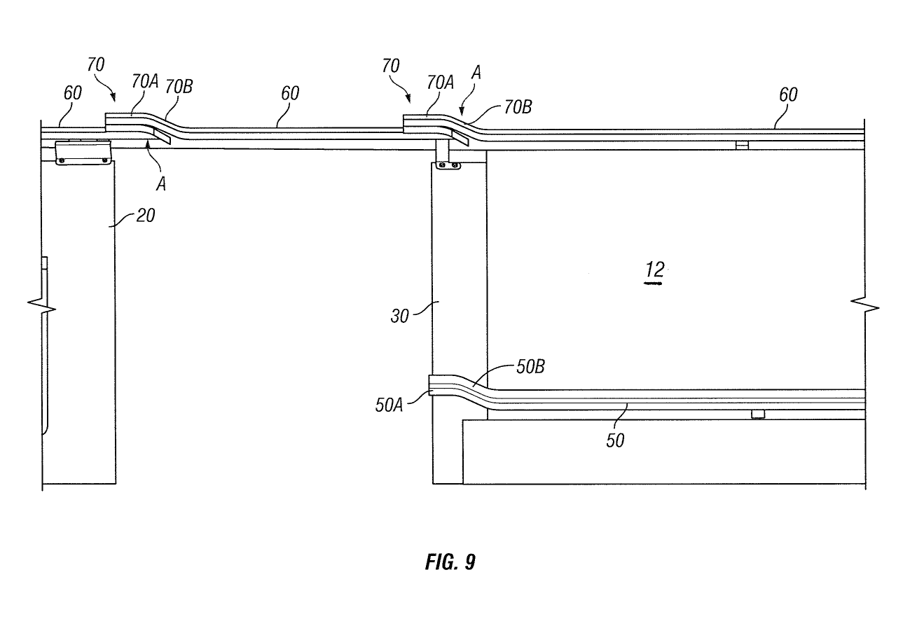

In the embodiment shown, each inner track 70 has an upper section 71, an outer section 72 extending generally perpendicular to upper section 71, an inwardly extending section 73 extending at an angle from outer section 72, an inner section 74 and an outwardly extending section 75 extending at an angle from inner section 74. As shown in FIGS. 6 and 9, a first section 70A of each inner track 70 extends parallel to outer track 60. From one end of section 70A, a second section 70B extends toward and merges with outer track 60.

Although not shown, middle track 50 in the embodiment shown has the same general cross-sectional configuration as outer track 60 and inner tracks 70. Note that middle track 50 also has a first section 50A and a second section 50B similar to inner tracks 70.

Front door 20 is supported by a plurality of rollers 80 that engage outer track 60. In one embodiment of the invention, front door 20 is provided with a front set of four rollers 80 and a rear set of four rollers 80. Note that rollers 80 are alternatingly arranged at 90 degree angles with respect to each other such that half of the rollers make contact with and ride on the inner surface of inwardly extending section 63 of outer track 60 and half make contact with and ride on the inner surface of outwardly extending section 65 of outer track 60.

Similarly, rear door 30 is supported by a front set of four rollers 90 and a rear set of four rollers 90. One set of rollers 90 engages the front inner track 70 and the other set of rollers 90 engages the rear inner track 70. Each set of rollers 90 is arranged such that half of the rollers make contact with and ride along the inner surface of inwardly extending section 73 of one inner track 70 and half make contact with and ride along the inner surface of outwardly extending section 75 of the same inner track 70 during part of the range of motion of rear door 30. During another part of the range of motion of rear door 30, half of the rollers 90 make contact with and ride on the inner surface of inwardly extending section 63 of outer track 60 and half make contact with and ride on the inner surface of outwardly extending section 65 of outer track 60, as described below.

As front door 20 is opened, rollers 80 will ride along outer track 60. Rollers 80 ride along outer track 60 in the opposite direction to close front door 20. Note that at least some of rollers 80 maintain contact with outer track 60 throughout the entire range of motion of front door 20.

As rear door 30 is opened, rollers 90 ride along inner tracks 70 until they reach the cut away portions of outer track 60 at locations A. At this point, rollers 90 ride outwardly along first sections 70A of inner tracks 70, on to second sections 70B and merge onto outer track 60. Rear door 30 may then be moved further along outer tack 60 to fully open rear door 30. Note that as rear door 30 is moved from the closed to the open position, it moves from a position flush with sidewall 12 of vehicle 10 to a position outward of side wall 12. As rear door 30 is closed, it merges from outer track 60 to inner tracks 70 at locations A and is once again flush with side wall 12 of vehicle 10. Note that throughout the entire range of motion of rear door 30, at least some of the rollers 90 remain in contact with either outer track 60 or an inner track 70.

In the embodiment described above, second sections 70B of inner tracks 70 are stationary. In an alternative embodiment, second sections 70B can be pivotable adjacent the ends that merge with outer track 60 such that sections 70B can selectively move from the position shown in FIGS. 6 and 9 to a position in line with outer track 60. In this embodiment, there would be two gaps in outer track 60 adjacent locations A to accommodate sections 70B. Note also that in this embodiment, all of the rollers 80 and 90 would remain in contact with either outer track 60, first sections 70A of inner track 70 or second sections 70B of inner track 70 throughout the entire range of motion of front door 20 and rear door 30.

In another embodiment of the invention, vehicle 10 includes a lockout mechanism that prevents opening rear door 30 when front door 20 is open and prevents opening front door 20 when rear door 30 is open. For example, in the embodiment in which second sections 70B of inner track 70 are moveable, actuation of the handles of front door 20 and rear door 30 could be used to trigger a lock associated with the other door. In one embodiment, when both front door 20 and rear door 30 are closed, second sections 70B are aligned with outer track 60. Actuating the handle of front door 20 actuates a locking mechanism associated with rear door 30, thereby preventing rear door 30 from opening. When front door 20 and rear door 30 are in the closed position, actuating the handle on rear door 30 causes second sections 70B to move to the orientation shown in FIGS. 6 and 9 and actuates a locking mechanism associated with front door 20 to prevent front door 20 from being opened. In this embodiment, closing rear door 30 causes second sections 70B to move back into alignment with outer track 60 and places both front door 20 and rear door 30 in the unlocked state.

In an alternative embodiment of the invention, vehicle 10 can be provided with one or more mechanisms positioned so as to be rearward of rollers 80 when front door 20 is in the closed position and that are moveable from an open orientation that permits movement of rollers 80 to a closed orientation that prevents movement of rollers 80. Similarly, vehicle 10 can be provided with one or more mechanisms positioned so as to be rearward of rollers 90 when rear door 30 is in the closed position and that are moveable from an open orientation that permits movement of rollers 90 to a closed orientation that prevents movement of rollers 90. In this embodiment, the mechanisms associated with rollers 80 and 90 are both in the open orientation when front door 20 and rear door 30 are both closed. Actuating the handle of front door 20 moves the mechanisms associated with rollers 90 to the closed orientation, thereby preventing rear door 30 from being opened. Similarly, when both doors are closed, actuating the handle on rear door 30 moves the mechanisms associated with rollers 80 to the closed orientation, thereby preventing front door 20 from being opened.

Vehicle 10 may also be provided with other lockout mechanisms that prevent opening front door 20 unless rear door 30 is closed and that prevent opening rear door 30 unless front door 20 is closed. For example, vehicle 10 could be provided with position sensors that selectively activate a locking mechanism on one door based on the position of the other door.

Although the present invention has been shown and described in detail the same is to be taken by way of example only and not by way of limitation. Numerous changes can be made to the embodiments described without departing from the scope of the invention. For example, the various tracks can have configurations other than those illustrated. Additionally, the rearward most section of outer track 60 could be eliminated and the rearward most inner track 70 could be a continuous member that angles outwardly away from first section 70A to a section in line with outer track 60. In this embodiment, there would be no need to cut away a portion of the rearward most inner track 70 at location A. Lock out mechanisms other than those described could also be utilized. Other modifications are also possible.

What is claimed is:

1. A vehicle including,
a sidewall;
a first door moveable between an opened position and a closed position;
a second door moveable between an opened position and a closed position;
a first track secured to the sidewall and a second track secured to the sidewall;
a first roller connected to the first door and moveable along the first track as the first door moves between the opened position and the closed position; and
a second roller connected to the second door, the second roller movable along the second track to the first track and along the first track to the second track as the second door is moved between the opened position and the closed position.
